(19) United States
(12) Patent Application Publication
(10) Pub. No.: US 2016/0154291 A1
(43) Pub. Date: Jun. 2, 2016

(54) LIQUID CRYSTAL COUPLED LIGHT MODULATION

(71) Applicant: HEWLETT-PACKARD DEVELOPMENT COMPANY L.P., Houston, TX (US)

(72) Inventors: Gary Gibson, Palo Alto, CA (US); David A. Fattal, Mountain View, CA (US)

(21) Appl. No.: 14/904,616

(22) PCT Filed: Jul. 30, 2013
(86) PCT No.: PCT/US13/52770

§ 371 Date: Jan. 12, 2016

(51) Int. Cl. G02F 1/315; G02F 1/139; G02F 1/19; G02B 27/22

(52) U.S. Cl. CPC G02F 1/315; G02B 27/2214; G02F 1/139; G02F 1/19

(57) ABSTRACT

Liquid crystal coupled light modulation includes a light guide to guide light by total internal reflection (TIR), a diffraction grating and a liquid crystal sandwiched between the diffraction grating and the light guide. The liquid crystal has a state with a first refractive index to defeat TIR and another state with a second refractive index to facilitate TIR at a surface of the light guide. The liquid crystal in the first refractive index state is to couple out a portion of the guided light to the diffraction grating and the diffraction grating is to provide diffractive redirection of the coupled portion out of the light modulator.

### CROSS-REFERENCE TO RELATED APPLICATIONS

N/A

### STATEMENT REGARDING FEDERALLY SPONSORED RESEARCH OR DEVELOPMENT

N/A

### BACKGROUND

Light modulators or more generally electro-optic modulators are employed in a variety of applications ranging from optical communications to electronic displays. For example, light modulators may be employed to modulate light emitted by a backlight in many modern electronic displays. The light modulators may modulate the emitted light in discrete, spatially separated regions of the electronic display representing pixels. Light emitted by the backlight is directed through and modulated by the light modulator to vary an intensity of the light emitted by the pixel, for example. Light modulators used in optical communications may employ any of a variety of means including, but not limited to, amplitude modulation, phase modulation and polarization modulation to encode information for transmission on an optical beam within an optical transmission line (e.g., a fiber optic cable).

As suggested above, light modulators may be used to vary or modulate one or more of amplitude or intensity, phase and polarization of a light beam, for example. Light modulators that modulate light using amplitude modulation (i.e., optical amplitude modulators) are sometimes referred to as light valves. Amplitude modulation in a light valve may be accomplished through a change in transmission (e.g., a transmissive light valve) or a change in reflection (e.g., a reflective light valve), for example. The change in transmission may result from a change in an absorption characteristic of the light valve, for example. A liquid crystal light valve typically provides amplitude modulation through a change in a transmission characteristic accomplished using a polarization shift of light passing through the liquid crystal light valve, for example. Reflection light valves may employ a change in direction of a light beam provided by a micromechanical mirror, for example, to affect amplitude modulation of the light beam. In addition, amplitude modulation may be accomplished using phase changes in the optical beam such as in an interferometric light valve, for example.

### BRIEF DESCRIPTION OF THE DRAWINGS

Various features of examples in accordance with the principles described herein may be more readily understood with reference to the following detailed description taken in conjunction with the accompanying drawings, where like reference numerals designate like structural elements, and in which:

FIG. 1 illustrates a cross sectional view of a liquid crystal coupled light modulator, according to an example consistent with the principles described herein.

FIG. 2 illustrates a cross sectional view of a liquid crystal coupled light modulator, according to another example consistent with the principles described herein.

FIG. 3A illustrates a cross sectional view of a portion of a liquid crystal coupled light modulator in a first state, according to an example consistent with the principles described herein.

FIG. 3B illustrates a cross sectional view of the portion of the liquid crystal coupled light modulator of FIG. 3A in a second state, according to an example consistent with the principles described herein.

FIG. 4 illustrates a block diagram of an electronic display, according to an example consistent with the principles described herein.

FIG. 5 illustrates a flow chart of a method of liquid crystal coupled light modulation, according to an example consistent with the principles described herein.

Certain examples have other features that are one of in addition to and in lieu of the features illustrated in the above-referenced figures. These and other features are detailed below with reference to the above-referenced figures.

### DETAILED DESCRIPTION

Examples in accordance with the principles described herein provide light modulation using liquid crystal based coupling between a light guide and a diffraction grating. In particular, light modulation described herein employs a selectively variable refractive index of a liquid crystal (e.g., birefringence) to change or modify whether guided light is coupled out of a light guide. The change in the liquid crystal based coupling out of guided light, in turn, changes an amount of the coupled out guided light that is communicated to a diffraction grating for diffractive redirection and emission.

Unlike polarization-based liquid crystal light modulation, light modulation according to the principles described herein does not employ a pair of crossed polarizers. As such, a more compact, efficient light modulator implementation may be provided that generally uses fewer layers and components than the polarization-based liquid crystal modulator. Among example applications of the light modulation using liquid crystal based coupling modulation described herein is a modulated backlight for an electronic display, for example. In another example, the light modulation described herein may provide a modulated light field (e.g., an array of modulated beams or beamlets) for a display such as, but not limited to, an autostereoscopic three-dimensional (3-D) display (e.g., a so-called ‘glasses-free’ 3-D display).

According to various examples of the principles described herein, a diffraction grating is employed to redirect light out of a light guide by diffractive redirection. Changes in a refractive index of a liquid crystal sandwiched between the diffraction grating and the light guide is used to alternately facilitate and defeat the coupling out of the light from the light guide and the communication of the coupled out light to the diffraction grating for diffractive redirection in order to modulate the coupled out light. The light guide may be a light guide of a backlight of an electronic display, for example. The diffraction grating includes or is made up of features (grooves, ridges, holes, bumps, material variation, etc.) arranged adjacent to the light guide, according to various examples.

The liquid crystal sandwiched between the diffraction grating and the light guide is in contact with a surface of the light guide. When the liquid crystal has a refractive index that matches or exceeds a refractive index of a material of the light guide, the liquid crystal substantially mitigates a refractive index condition for total internal reflection within the light guide at the surface. As such, the light guide no longer supports total internal reflection and thus total internal reflection is defeated (i.e., at the light guide surface that is in contact with the liquid crystal). Alternatively, when the liquid crystal exhibits a refractive index that is less than a refractive index of the light guide material, the light guide operates normally to guide the light by total internal reflection. Moreover, the liquid crystal may be switched between a first refractive index that matches or exceeds the refractive index of the light guide material, i.e., ‘a light guide refractive index,’ and a second refractive index that is less than the light guide refractive index, according to various examples. Switching may be provided by changing a state of the liquid crystal (e.g., an orientation of molecules within the liquid crystal), for example. The state change may be provided by an applied electric field, according to some examples. In other examples, the state change may be provided by another means including, but not limited to, a change in temperature.

Herein, a ‘diffraction grating’ is defined as a plurality of features arranged to provide diffraction of light incident on the features. Further by definition herein, the features of a diffraction grating may be features formed one or more of at, in and on a surface of a material or structure layer that provides or supports the diffraction grating. For example, the material layer may be a sheet of material (e.g., a dielectric) that is adjacent to but spaced apart from a light guide surface. The features may include any of a variety of features or structures that diffract light including, but not limited to, grooves, ridges, holes and bumps on the material surface. For example, the diffraction grating may include a plurality of parallel grooves in the material surface. In another example, the diffraction grating may include a plurality of parallel ridges rising out of the material surface. In some examples, the features may include material variations within the material surface (e.g., a variation in material refractive index).

According to some examples, the diffraction grating is substantially transparent (i.e., substantially non-absorbing at an operational wavelength of the diffraction grating) allowing light to pass through the diffraction grating. Such a substantially transparent diffraction grating is referred to as a ‘transmissive’ diffraction grating, by definition herein. In other examples, the diffraction grating includes a reflective material (e.g., a metal layer) and light incident on the diffraction grating is reflected from a surface of the diffraction grating in addition to being diffracted. A diffraction grating including a reflective material is a ‘reflective’ diffraction grating, by definition.

In some examples, the plurality of features of the diffraction grating may be arranged in a periodic array. In other examples, the diffraction grating may include features arranged in an aperiodic array. In some examples, the diffraction grating may include a plurality of features arranged in a one-dimensional (1-D) array. For example, a plurality of parallel grooves is a 1-D array. In other examples, the diffraction grating may include a two-dimensional (2-D) array of features. For example, the diffraction grating is a 2-D array of bumps on a material surface. The features (e.g., grooves, ridges, holes, bumps, etc.) may have any of a variety of cross sectional shapes or profiles that provide diffraction including, but not limited to, one or more of a rectangular profile, a triangular profile and a saw tooth profile.

Herein, ‘diffractive redirection’ is defined as redirection of an electromagnetic wave (e.g., light) as a result of diffraction (e.g., by a diffraction grating). For example, a diffraction grating may be used to redirect light coupled out of a light guide by diffractive redirection. The diffractive redirection substantially occurs at a diffraction angle θₘ, for example. The diffraction angle θₘ provided by a periodic, transmissive diffraction grating may be given by equation (1) as:

$${θ}_{m} = {sin}^{- 1} ( \frac{m λ}{d} - n \cdot sin {θ}_{i} ) \qquad ( 1 )$$

where λ is a wavelength of the light, m is a diffraction order, d is a distance between features of the diffraction grating, θₜ is an angle of incidence of the light on the diffraction grating, and n is a refractive index of a material (e.g., a liquid crystal) on a side of the diffraction grating from which light is incident on the diffraction grating (i.e., ‘light-incident’ side). Equation (1) assumes that a refractive index on a side of the diffraction grating opposite the light-incident side has a refractive index of one. If the refractive index on the side opposite the light-incident side is not one, then equation (1) may be modified accordingly.

Further herein, a ‘light guide’ is defined as a structure that guides light within the structure using total internal reflection. In particular, the light guide may include a core that is substantially transparent at an operational wavelength of the light guide. In some examples, the term ‘light guide’ generally refers to a dielectric optical waveguide that provides total internal reflection to guide light at an interface between a dielectric material of the light guide and a material or medium that surrounds that light guide. By definition, a condition for total internal reflection is that a refractive index of the light guide is greater than a refractive index of a surrounding medium directly adjacent to a surface of the light guide material. In some examples, the light guide may include a coating in addition to or instead of the aforementioned refractive index difference to either provide or to further facilitate the total internal reflection. The coating may be a reflective coating, in some examples. According to various examples, the light guide may be any of several light guides including, but not limited to, one or both of a plate or slab guide and a strip guide.

Further herein, the term ‘plate’ when applied to a light guide as in a ‘plate light guide’ is defined to mean a piecewise or differentially planar layer or sheet. In particular, a plate light guide is defined as a light guide configured to guide light in two substantially orthogonal directions bounded by a top surface and a bottom surface of the light guide. Further, by definition herein, the top and bottom surfaces are both separated from one another and substantially parallel to one another in a differential sense. That is, within any differentially small region of the plate light guide, the top and bottom surfaces are substantially parallel or co-planar. In some examples, a plate light guide may be substantially flat (e.g., confined to a plane) and so the plate light guide is a planar light guide. In other examples, the plate light guide may be curved in one or two orthogonal dimensions. For example, the plate light guide may be curved in a single dimension to form a cylindrical shaped plate light guide. In various examples, however, any curvature to the plate light guide has a radius of curvature sufficiently large to insure that total internal reflection is maintained within the plate light guide to guide light.

A ‘liquid crystal’ or a ‘liquid crystal material’ is defined herein as a fluid or liquid that has properties of a crystal. In particular, a liquid crystal may exhibit one or more of a nematic phase, a Smectic phase, a chiral phase or discotic phase, according to various examples herein. Further, liquid crystals or liquid crystal materials may exhibit birefringence. Birefringence is a property of a material where light with different polarizations may experience different refractive indices as the light passes through or interacts with the material. For example, a birefringent crystal material such as a birefringent liquid crystal may exhibit both a so-called ‘ordinary’ refractive index (nₒ) and an ‘extraordinary’ refractive index (nₑ) depending on a particular polarization of the light. In liquid crystals, selection between the ordinary refractive index nₒ and the extraordinary refractive index nₑ may be provided by selecting a state of the liquid crystal. In particular, depending on an orientation of molecules of the liquid crystal, light having a particular polarization may experience a different refractive index (e.g., nₒ vs. nₑ) depending on the state of the liquid crystal. Further, the state of the liquid crystal and by extension, the refractive index thereof, may be switched or changed (e.g., by application of heat, electric field, etc.) to selectively change the refractive index, according to various examples.

Herein, a ‘state’ of a liquid crystal is defined as a predetermined orientation of molecules of the liquid crystal. For example, rod-like molecules in a nematic phase liquid crystal (i.e., a nematic liquid crystal) may be characterized by a so-called ‘director’ that points in a direction parallel with a long axis of the rod-like molecules. The state of the nematic liquid crystal may be switched (e.g., by applying an electric field) between (a) an alignment of the director that is substantially parallel to a substrate and (b) an alignment of the director that is substantially perpendicular to the substrate. The substantially parallel alignment is referred to as a ‘homogeneous alignment’ and the substantially perpendicular alignment is referred to as a ‘homeotropic alignment’, by definition herein. Light having, for example, a transverse electric (TE) polarization will experience different refractive indices depending on whether the liquid crystal is set to a state corresponding to the homogeneous alignment or another state corresponding to the homeotropic alignment, for example. As such, the state of the liquid crystal may be used to selectively control the refractive index experienced by the light passing through or interacting with the liquid crystal. Further, a liquid crystal may have one or more ‘refractive index’ states based on different refractive indices that may be produced for given polarizations by different states of the liquid crystal.

Further still, as used herein, the article ‘a’ is intended to have its ordinary meaning in the patent arts, namely ‘one or more’. For example, ‘a grating’ means one or more gratings and as such, ‘the grating’ means ‘the grating(s)’ herein. Also, any reference herein to ‘top’, ‘bottom’, ‘upper’, ‘lower’, ‘up’, ‘down’, ‘front’, back’, ‘left’ or ‘right’ is not intended to be a limitation herein. Herein, the term ‘about’ when applied to a value generally means within the tolerance range of the equipment used to produce the value, or in some examples, means plus or minus 10%, or plus or minus 5%, or plus or minus 1%, unless otherwise expressly specified. Further, herein the term ‘substantially’ as used herein means a majority, or almost all, or all, or an amount with a range of about 51% to about 100%, for example. Moreover, examples herein are intended to be illustrative only and are presented for discussion purposes and not by way of limitation.

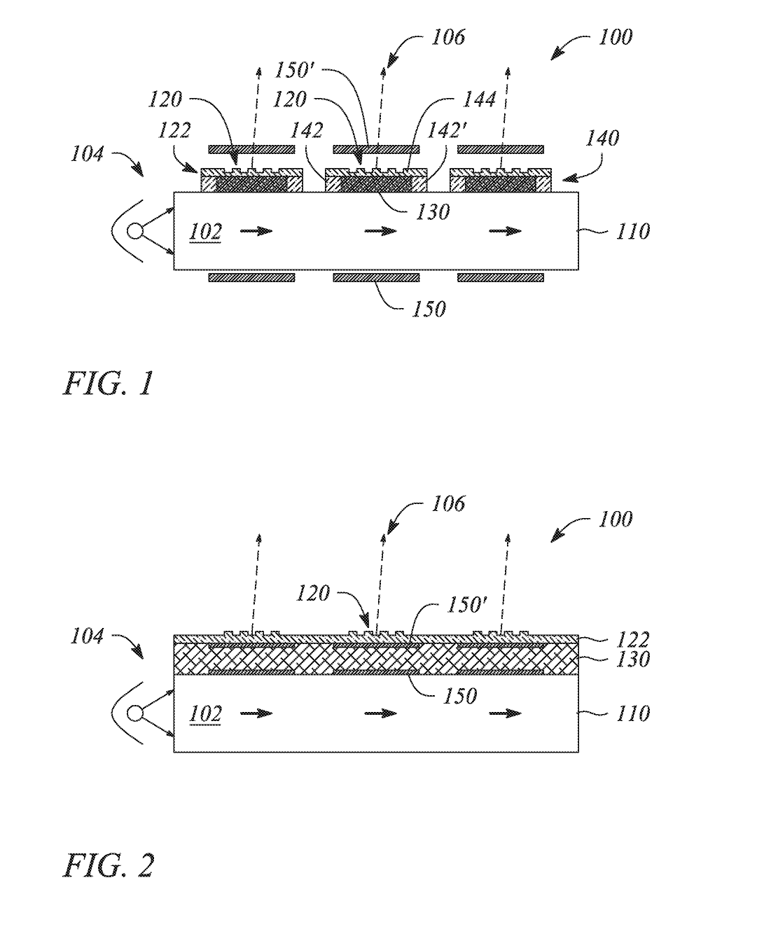

According to some examples of the principles described herein, a liquid crystal coupled light modulator is provided. FIG. 1 illustrates a cross sectional view of a liquid crystal coupled light modulator 100, according to an example consistent with the principles described herein. FIG. 2 illustrates a cross sectional view of a liquid crystal coupled light modulator 100, according to another example consistent with the principles described herein. The liquid crystal coupled light modulator 100 is configured to couple out and modulate a portion of light that propagates a guided light 102 within the liquid crystal coupled light modulator 100. Both the coupling out and the modulation are provided using a liquid crystal (LC) to modulate coupling between a light guide and a diffraction grating. The diffraction grating is configured to provide diffractive redirection of the coupled portion of the light 102 from the light modulator, according to various examples.

In particular, the light from a light source 104 propagates as guided light 102 in the liquid crystal coupled light modulator 100. A general propagation direction of the guided light 102 within the liquid crystal coupled light modulator 100 (i.e., before being coupled out) is illustrated by bold arrows in FIGS. 1 and 2. The liquid crystal coupled light modulator 100 emits the coupled out and modulated portion of the guided light 102 as modulated light 106 (illustrated by dashed-line arrows in FIGS. 1 and 2). The modulated light 106 may be emitted as a beam of light, for example. In various examples, the beam of modulated light 106 may have both a predetermined direction and a relatively narrow angular spread. The modulated light 106 is configured to propagate in a direction away from the liquid crystal coupled light modulator 100. The modulated light 106 propagation direction is substantially different from a propagation direction of the guided light 102 within the liquid crystal coupled light modulator 100. As a light beam, the modulated light 106 may propagate in a direction that is substantially perpendicular to a general propagation direction of the guided light 102 propagating within the liquid crystal coupled light modulator 100, for example.

The modulated light 106 (e.g., a modulated light beam) has an intensity or brightness determined by or that is a function of a state of a liquid crystal used to modulate the coupling out of light, or ‘light coupling’. In some examples, the LC modulated light coupling is configured to switch or change the intensity of the modulated light 106 between two states. A first or ‘ON’ state of the two states may be a full or maximum intensity of the modulated light 106, while a second or ‘OFF’ state may represent a minimum intensity (i.e., substantially no light) of the modulated light 106 that is produced by the liquid crystal coupled light modulator 100. In other examples, the LC modulated light coupling may produce modulated light 106 having a plurality of intensity values or states. The plurality of intensity states may range between the ON state and the OFF state, inclusively.

In various examples, the light source 104 may be substantially any source of light including, but not limited to, one or more of a light emitting diode (LED), a fluorescent light and a laser. In some examples, the light source 104 may produce guided light 102 that is substantially monochromatic having a narrowband spectrum denoted by a particular color. In particular, the color of the monochromatic guided light 102 may be a primary color of a particular color gamut or color model (e.g., a red-green-blue (RGB) color model). The light source 104 may be a red LED and the monochromatic guided light 102 is substantially the color red. The light source 104 may be a green LED and the monochromatic guided light 102 is substantially green in color. The light source 104 may be a blue LED and the monochromatic guided light 102 is substantially blue in color. In other examples, the guided light 102 provided by the light source 104 has a substantially broadband spectrum. For example, the guided light 102 produced by the light source 104 may be white light. The light source 104 may be a fluorescent light that produces white light.

As illustrated in FIGS. 1 and 2, the liquid crystal coupled light modulator 100 includes a light guide 110. The light guide 110 may include a slab or plate light guide, for example. The light guide 110 is configured to guide the light from the light source 104. In particular, the light guide 110 guides the light as the guided light 102 using total internal reflection, according to various examples.

The light guide 110 may include a dielectric material configured as an optical waveguide. The dielectric material may have a refractive index that is greater than a refractive index of a medium surrounding the dielectric optical waveguide. The difference between the refractive indices of the dielectric material and the surrounding medium is configured to facilitate total internal reflection of the guided light 102, according to one or more guided modes in the light guide 110. In some examples, the guided light 102 may be coupled into an end of the light guide 110 to propagate along a length thereof. A lens (not illustrated) may facilitate coupling of light into the light guide 110 at the end thereof, for example.

In some examples (e.g., as illustrated in cross section in FIG. 1), the light guide 110 is a slab or plate optical waveguide. The slab or plate optical waveguide may be a sheet of optically transparent material that is substantially solid, according to some examples. In some examples, the light guide 110 may include a cladding layer on a portion of a surface of the light guide 110 (not illustrated). The cladding layer may be used to further facilitate total internal reflection. In some examples, the sheet of optically transparent material of the light guide 110 is an extended, substantially planar sheet of dielectric material. According to various examples, the optically transparent material may include or be made up of any of a variety of dielectric materials including, but not limited to, various types of glass (e.g., silica glass, alkali-aluminosilicate glass, borosilicate glass, etc.) and optically transparent plastics or polymers (e.g., poly(methyl methacrylate) or acrylic glass, polycarbonate, etc.).

As illustrated by the solid arrows in FIGS. 1 and 2, the guided light 102 from the light source 104 may propagate along the light guide 110 in a generally horizontal direction. Propagation of the guided light 102 in the generally horizontal propagation direction may be according to one or more optical beams that represent plane waves of propagating light associated with one or more of the optical modes of the light guide 110, as noted above. In particular, optical beams of the guided light 102 may substantially bounce or reflect off ‘walls’ of the light guide 110 at an interface between the material (e.g., dielectric) of the light guide 110 and the surrounding medium due to the difference in refractive indices between the material of the light guide 110 and the surrounding medium. The total internal reflection occurs when the optical beams encounter the interface at an angle of incidence θᵢ that is greater than a critical angle θ_{c} for the interface and the surrounding medium (i.e., the medium outside of the light guide 110 at the interface) has a refractive index that is less than the light guide refractive index (i.e., total internal reflection conditions). Herein, the critical angle θ_{c} is defined as an angle measured relative to an interface normal given by θ_{c}=arcsin(n₂/n₁), where n₁ is the light guide refractive index and n₂ is the refractive index of the surrounding medium outside of the light guide 110. The total internal reflection is responsible for guiding the guided light 102 in the light guide 110, according to various examples.

The liquid crystal coupled light modulator 100 illustrated in FIGS. 1 and 2 further includes a diffraction grating 120. FIGS. 1 and 2 illustrate a plurality of diffraction gratings 120 by way of example. As illustrated in FIGS. 1 and 2, the diffraction grating 120 is adjacent to but separated or spaced apart from a surface of the light guide 110. The diffraction grating 120 is configured to diffractively redirect a portion of the guided light 102 coupled out through the surface of the light guide 110, as described below. According to various examples, the diffraction grating 120 diffractively redirects the coupled out portion of the guided light 102 in a direction that is different from a direction of propagation of the guided light 102 in the light guide 110. The diffractively redirected, coupled out portion of the guided light 102 may be directed away from the surface of the light guide 110 at a diffraction angle relative to the surface. The diffraction angle may be between 60 and 120 degrees, for example. As illustrated in FIGS. 1 and 2, the diffraction angle is about 90 degrees, by way of example. The coupled out portion of the guided light 102 is the modulated light 106 emitted from the liquid crystal coupled light modulator 100. The dashed line arrows are used in FIGS. 1 and 2 to illustrate the modulated light 106 to further emphasize modulation thereof.

The diffraction grating 120 may include a plurality of grooves or ridges that either penetrate into or extend from, respectively, a surface of a material layer. The grooves may be milled or molded into the material layer surface. For example, FIG. 1 illustrates the diffraction grating 120 as a plurality of parallel grooves that penetrate a top surface of a material layer 122 adjacent to but space apart from the light guide 110. The material layer 122 may be a lid 144 of a cavity 140, described below, according to some examples. In another example (not illustrated), the diffraction grating 120 may be formed in a bottom surface of the material layer 122. The material layer 122 may include a dielectric and thus be a dielectric material layer, for example. Further, the material layer 122 may be substantially transparent at an operational wavelength of the liquid crystal coupled light modulator 100, according to various examples.

In other examples (not illustrated), the diffraction grating 120 may be a film or layer applied or affixed to a surface of the material layer 122. According to various examples, the film may include bumps, groove, etc. to form the diffraction grating 120. For example, the film or layer that provides the diffraction grating 120 may be applied to the top surface of the material layer 122. In another example (not illustrated), the film or layer that provides the diffraction grating 120 may be applied to the bottom surface of the material layer 122.

In yet other examples, the diffraction grating 120 may include a material variation within the material layer 122 itself. For example, the material layer 122 may have a refractive index that varies in a direction substantially parallel with a surface of the material layer 122 to produce diffraction. In still other examples, the diffraction grating 120 may be a layer patterned to provide diffraction including, but not limited to, a patterned metal layer (e.g., as thin strips of metal). A patterned metal layer may be used as a reflective diffraction grating 120, for example.

In some examples, the diffraction grating 120 is a transmissive diffraction grating 120 in which light that is diffractively redirected passes or is transmitted substantially through the diffraction grating 120. In other examples, the diffraction grating 120 is a reflective diffraction grating 120 and incident light is both diffractively redirected and reflected by the diffraction grating 120. In some examples, the grooves, ridges or other features that define the diffraction grating 120 are substantially perpendicular to a propagation direction of the guided light 102 in the light guide 110. In other examples, the grooves, ridges or other features may be oriented on the surface at a slant to the propagation direction (e.g., an angle other than perpendicular).

The liquid crystal coupled light modulator 100 further includes a liquid crystal 130 sandwiched between the diffraction grating 120 and the light guide 110. For example, the liquid crystal 130 may be sandwiched between the material layer 122 that includes or carries the diffraction grating 120 and a top surface of the light guide 110, as illustrated in FIGS. 1 and 2.

In various examples, the liquid crystal 130 is in contact with a surface of the light guide 110. The liquid crystal 130 may be in contact with only a portion of the light guide surface, in some examples. For example, as illustrated in FIG. 1, the liquid crystal 130 is in contact with only a portion of the light guide surface corresponding to a vicinity of the diffraction grating 120. On the other hand, FIG. 2 illustrates the liquid crystal 130 in contact with substantially an entire top surface of the light guide 110.

The liquid crystal 130 has a state with a first refractive index (i.e., a first refractive index state) configured to defeat total internal reflection at a surface of the light guide 110. In some examples, the first refractive index is configured to either substantially match or exceed a refractive index of the light guide 110 (or a material thereof). The first refractive index defeats total internal reflection at the surface of the light guide 110 by substantially violating or not supporting the condition for total internal reflection). In particular, by ‘defeat the total internal reflection’ herein it is meant that total internal reflection is substantially prevented or mostly does not occur, at the surface in contact with the liquid crystal 130 having the first refractive index. In particular, the first refractive index of the liquid crystal 130 in contact with a surface the light guide 110 may substantially defeat total internal reflection at the surface because the total internal reflection condition is not supported by the first refractive index at the light guide surface. Defeating total internal reflection at the surface allows a portion of the guided light 102 to escape or leak out of the light guide 110 and into the liquid crystal 130.

Further, the liquid crystal 130 has another state with a second refractive index (i.e., second refractive index state) configured to facilitate total internal reflection within the light guide 110. By ‘facilitate the total internal reflection’, it is meant herein that total internal reflection can or does occur at the surface in contact with the liquid crystal 130. In particular, the second refractive index at the surface meets or exceeds the total internal reflection condition of the light guide 110. According to various examples, the second refractive index is generally less than and in some examples, substantially less than the refractive index of the light guide 110.

In some examples, the first refractive index may be the ordinary refractive index nₒ while the second refractive index may be the extraordinary refractive index nₑ. In other examples, the first refractive index may be the extraordinary refractive index nₑ and the second refractive index may be the ordinary refractive index nₒ. In yet other examples, one or both of the first and second refractive indices of the liquid crystal 130 may be other than the extraordinary refractive index nₑ and the ordinary refractive index nₒ.

According to some examples, the refractive index of the light guide material (‘light guide refractive index’) and the first refractive index of the first refractive index state of the liquid crystal are defined as being ‘substantially matched’ when the respective refractive indices have values that are within about 10 percent to about 20 percent of one another, or less. In some examples, the refractive indices are considered matched when a difference therebetween is less than about 5 percent. In some examples, the first refractive index of the liquid crystal 130 and the refractive index of the light guide 110 are considered to be matched when they differ by less than about 1 percent. For example, a first refractive index of about 1.55 may be considered to match or exceed a light guide refractive index of about 1.5, by definition herein. The first refractive index exceeds the light guide refractive index, by definition, when the first refractive index is greater than the light guide refractive index. For example, if the first refractive index is 1 percent greater than the light guide refractive index, then the first refractive index ‘exceeds’ the light guide refractive index, by definition.

In various examples, the second refractive index of the liquid crystal 130 is configured to be low enough relative to the light guide refractive index to substantially confine light within the light guide 110 by total internal reflection. In particular, the second refractive index may be considered to be ‘less’ than the refractive index of the light guide 110 when the total internal reflection condition of the light guide 110 is met, by definition herein. In some examples, the second refractive index is considered to be low enough or less than the light guide refractive index when the respective refractive index values differ from one another by more than about 5 percent to about 20 percent and the refractive index of the light guide material is greater than the second refractive index. For example, a second refractive index of about 1.4 is about 7 percent ‘less’ than a light guide refractive index of about 1.5 and thus will facilitate total internal reflection. However, as long as the second refractive index is less than the refractive index of the light guide may still substantially facilitate total internal reflection and therefore be employed, according to some examples.

As mentioned above, the liquid crystal 130 may be substantially confined to a portion of the light guide surface associated with the diffraction grating 120. In particular, as illustrated in FIG. 1, the liquid crystal 130 is confined substantially outside of and in contact with the top surface of the light guide 110. Further, the liquid crystal 130 illustrated in FIG. 1 is located below the diffraction grating 120, i.e., between the diffraction grating 120 and the light guide 110. The liquid crystal 130 may be confined in a vicinity of the diffraction grating 120 by or within a housing or cavity on the surface of the light guide 110, for example.

In particular, the liquid crystal coupled light modulator 100 may further include a cavity 140 to confine the liquid crystal 130 outside of and adjacent to the surface of the light guide 110. The cavity 140 may include a pair of walls 142, 142′ adjacent to and extending away from the light guide surface. The cavity 140 further includes a lid 144 to bridge between the walls 142, 142′ to further confine the liquid crystal 130. The lid 144 may be the material layer 122 (e.g., a dielectric material layer) that supports or includes the diffraction grating 120, as illustrated in FIG. 1. Together the pair of walls 142, 142′ and the lid 144 are configured to confine the liquid crystal 130 in contact with the surface of the light guide 110. The lid 144 may be made of an optically transparent dielectric material (e.g., glass or plastic). Further, the lid 144 may include or at least support the diffraction grating 120. In some examples, the walls 142, 142′ also may be made of an optically transparent dielectric material.

In other examples (see FIG. 2), the liquid crystal 130 is located within layer or space along a portion (e.g., an entire length) of the light guide 110 that is associated with a plurality of diffraction gratings 120. In particular, the liquid crystal 130 may be confined between the light guide 110 and a material layer or sheet 122 that is substantially parallel to the light guide 110, as illustrated in FIG. 2. The diffraction gratings 120 may be located on the material layer or sheet 122, for example.

The liquid crystal 130 may include substantially any liquid crystal material that has a first state and a second state with differing refractive indices, where a refractive index of one of the states substantially matches or exceeds the light guide refractive index to defeat total internal reflection. For example, the liquid crystal 130 may include one or more of a nematic liquid crystal (i.e., liquid crystal materials that exhibit a nematic phase, a chiral or a cholesteric nematic phase, etc.), a Smectic liquid crystal (e.g., liquid crystal materials that exhibit Smectic phase A or Smectic phase C), a discotic phase liquid crystal, and a various other birefringent liquid crystal materials, as described above.

In some examples, the liquid crystal 130 includes a nematic liquid crystal in which a state (e.g., the first refractive index state) is characterized by a homogeneous alignment of molecules of the nematic liquid crystal and another state (e.g., the second refractive index state) is provided by a homeotropic alignment of the nematic liquid crystal molecules. The homogeneous alignment may provide the first refractive index and the homeotropic alignment may provide the second refractive index. Alternatively, the homeotropic alignment may provide the first refractive index and the homogeneous alignment may provide the second refractive index, in other examples.

For example, transverse electric (TE) polarized light (e.g., light 102) may experience a relatively higher refractive index when passing through or encountering the nematic liquid crystal 130 in a first refractive index state provided by the homogeneous alignment. The TE polarized light may experience a relatively lower refractive index when encountering the same nematic liquid crystal 130 in a second refractive index state resulting from the homeotropic alignment. The relatively higher refractive index of the first refractive index state may either substantially match or exceed the refractive index of the light guide 110 such that total internal reflection is defeated for the TE polarized light. As such, modulated light 106 may be coupled out of the light guide 110 and diffractively redirected by the diffraction grating 120 to produce an emission (i.e., the modulated light 106) from the liquid crystal coupled light modulator 100 when the nematic liquid crystal 130 is in the first refractive index state and the guided light 102 is TE polarized. Alternatively, the refractive index experienced by the TE polarized light with the nematic liquid crystal 130 in the homeotropic alignment may be sufficiently lower than the refractive index of the light guide 110 to facilitate total internal reflection and therefore, substantially prevent or at least minimize emission of modulated light 106 from the liquid crystal coupled light modulator 100.

In another example, light with a transverse magnetic (TM) polarization (e.g., light 102) may experience a relatively lower refractive index when interacting with the nematic liquid crystal 130 in the homogeneous alignment and a relatively higher refractive index when encountering the same nematic liquid crystal 130 having the homeotropic alignment. Still, if the relatively higher refractive index (second refractive index state) is either substantially matched to or exceeds the refractive index of the light guide material, total internal reflection may be defeated. As such, total internal reflection may be defeated with the nematic liquid crystal 130 in the homeotropic alignment for the TM polarized light. The defeated total internal reflection means that the guided light 102 is coupled out from the light guide 110 and diffractive redirection of the coupled out light by the diffraction grating 120 may be facilitated. It should be clear that various other permutations of refractive indices (i.e., the first and second refractive index states), light polarization and light guide refractive index are possible. All such permutations are within the scope of the principles described herein.

Examples of liquid crystal materials that may be used as the liquid crystal 130 include, but are not limited to, 4′-Pentyl-4-biphenylcarbonitrile, 4-trans-pentylcyclohexylcyanobenzene, MLC-9200-00, MLC-9200-100, MLC-6241-000, MLC-6608, TL-216, and E44. For example, 4′-Pentyl-4-biphenylcarbonitrile in a homeotropic alignment exhibits a refractive index of about 1.5 for TE polarized light and a refractive index of about 1.7 for TM polarized light. However, when in a homogeneous alignment, 4′-Pentyl-4-biphenylcarbonitrile exhibits a refractive index of about 1.7 for TE polarized light and about 1.5 for TM polarized light. 4′-Pentyl-4-biphenylcarbonitrile is available from Sigma-Aldrich. LLC, St. Louis, Mo., USA, as 5CB liquid crystal. 4-trans-pentylcyclohexylcyanobenzene is available as 5PCH liquid crystal, manufactured by Maison Chemical Co. Ltd, China. The liquid crystals MLC-9200-00, MLC-9200-100, MLC-6241-000, MLC-6608, TL-216, E44 are manufactured by Merck, Darmstadt, Germany.

In some examples, the liquid crystal coupled light modulator 100 further includes an electrode 150. The electrode 150 is used to provide an electric field that produces one or both of the first refractive index state and the second refractive index state of the liquid crystal 130. For example, the electric field may produce the first refractive index state of the liquid crystal 130, while an absence of the electric field may allow the liquid crystal 130 to return to the second refractive index state. In other examples, the second refractive index state may be produced by application of the electric field while the first refractive index state is provided by an absence of the electric field. In yet other examples, a first electric field provided by the electrode 150 produces the first refractive index state and a second electric field provided by the electrode 150 produces the second refractive index state of the liquid crystal 130.

In some examples, a plurality of electrodes 150 may be employed to produce the electric field across the liquid crystal 130. In particular, the liquid crystal coupled light modulator 100 may include a first electrode 150 and a second electrode 150′ positioned on opposite sides of the liquid crystal 130 to provide the electric field across the liquid crystal 130, according to some examples. In FIG. 1, the second electrode 150′ is illustrated above the lid 144 of the cavity 140 and the first electrode 150 is illustrated at a back surface of the light guide 110, by way of example and not limitation. In another example (not illustrated), the first electrode 150 may be located on a backside or bottom of the cavity 140 (e.g., on the light guide surface) instead of the back surface of the light guide 110. In yet another example, as illustrated in FIG. 2, the electrodes 150, 150′ may be located on opposing surfaces above and below the liquid crystal 130 (e.g., a bottom surface of the diffraction grating 120 and a top surface of the light guide 110). In some examples, pairs of the first and second electrodes 150, 150′ may be aligned with corresponding diffraction gratings 120 of a plurality of diffraction gratings 120, e.g., as illustrated in FIG. 2. According to various examples, one or both of the first electrode 150 and the second electrodes 150′ may include a transparent conductor material such as, but not limited to, indium tin oxide (ITO), fluorine doped tin oxide (FTO), doped zinc oxide, or various conductive organic films.

An electric field provided by application of a first voltage to the electrodes 150, 150′ may be used to one or both of change the state and set the first refractive index state of the liquid crystal 130 in contact with the light guide 110. Further, application of a second voltage to the electrodes 150, 150′ may be used to one or both of change the state and set the second refractive index state of the liquid crystal 130. In some examples, one of the first and the second voltages may be approximately zero volts (0 V) while the other voltage is substantially different from zero volts to cause the change or set the state. In some examples, one or both of the first and second voltages represent an alternating current (AC) voltage. The pairs of first and second electrodes 150, 150′ may be selectively activated to turn ON or turn OFF the corresponding diffraction gratings 120 along the light guide 110, according to various examples.

In some examples, the liquid crystal coupled light modulator 100 is substantially transparent. In particular, the light guide 110, the diffraction grating 120 and at least the liquid crystal 130 in the first refractive index state may be optically transparent in a direction orthogonal to a direction of light propagation in the light guide 110, according to some examples. Optical transparency may allow objects on one side of the liquid crystal coupled light modulator 100 to be seen from an opposite side, for example.

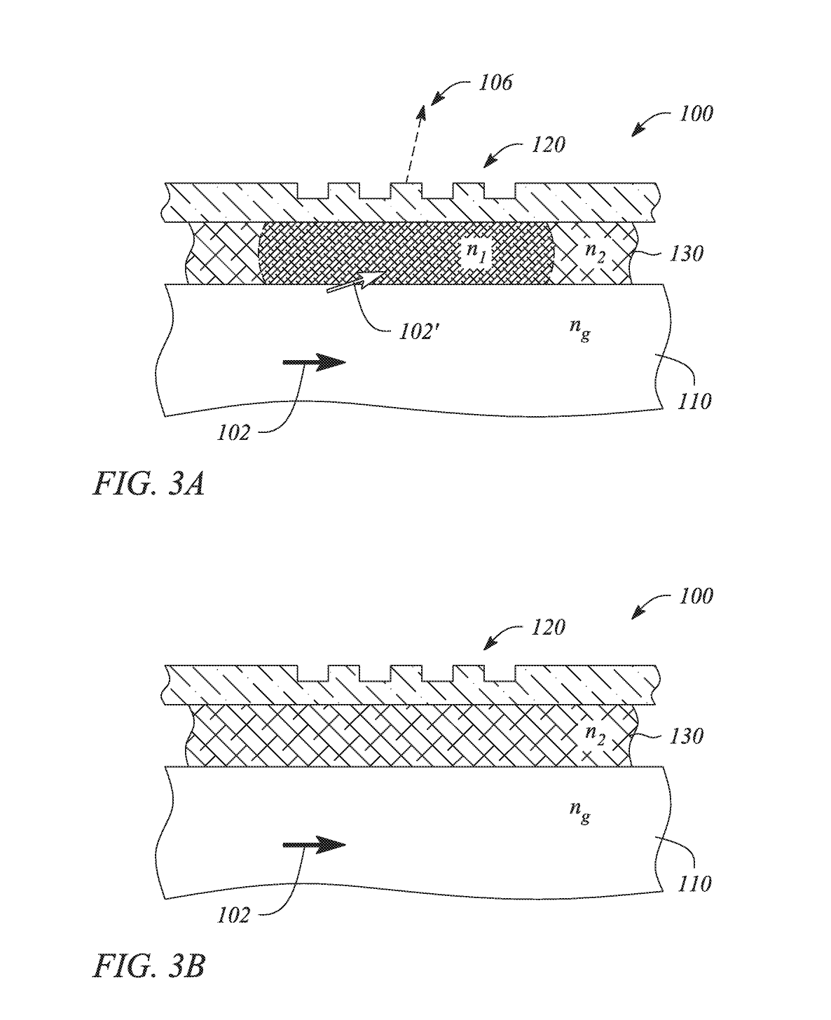

FIG. 3A illustrates a cross sectional view of a portion of a liquid crystal coupled light modulator 100, according to an example consistent with the principles described herein. FIG. 3B illustrates a cross sectional view of the portion of the liquid crystal coupled light modulator 100 of FIG. 3A, according to an example consistent with the principles described herein. In particular, FIG. 3A illustrates the liquid crystal coupled light modulator 100 with the liquid crystal 130 in the first refractive index state having the first refractive index n₁ that matches or exceeds the refractive index n_{g} of a material of the light guide 110 (i.e., n₁≧n_{g}). FIG. 3B illustrates the liquid crystal 130 is in the second refractive index state with the second refractive index n₂ that is less than the light guide refractive index n_{g} (i.e., n₂<n_{g}). Further, FIGS. 3A and 3B illustrate the liquid crystal 130 confined substantially outside of but in contact with the light guide surface.

As illustrated in FIG. 3A, the relative values of the refractive indices of the liquid crystal 130 and the light guide 110 defeats the total internal reflection and the guided light 102 is coupled out of the light guide 110 and to the diffraction grating 120. The coupled out light 102′ is illustrated by a hollow arrow in FIG. 3A. For example, the refractive index of the light guide material may be about 1.7 and the first refractive index state of the liquid crystal 130 may be provide by a homeotropic alignment of the liquid crystal molecules resulting in a refractive index of about 1.7 (i.e., for guided light 102). The match between the refractive indices at 1.7 causes the surface of the light guide 110 to appear substantially indistinct from the liquid crystal 130 thus defeating the total internal reflection of the light 102 guided in the light guide 110.

In FIG. 3B, the liquid crystal 130 has been switched to the second refractive state provided by a homogeneous alignment of the liquid crystal 130 molecules that have a refractive index of about 1.5 (i.e., for the guided light 102). As illustrated in FIG. 3B, the refractive index of the liquid crystal 130 being less than the refractive index of the light guide 110 facilitates total internal reflection. As such, the guided light 102 is not coupled out of the light guide 110, as illustrated in FIG. 3B.

In some examples, as illustrated by darker hatched regions in FIG. 3A, the first refractive index state may be provided (e.g., by application of an electric field) only in a vicinity of the diffraction grating 120. Outside of the diffraction grating vicinity, the liquid crystal may be maintained in the second refractive index state to promote guiding of the guided light 102 by total internal reflection along the light guide 110, as illustrated.

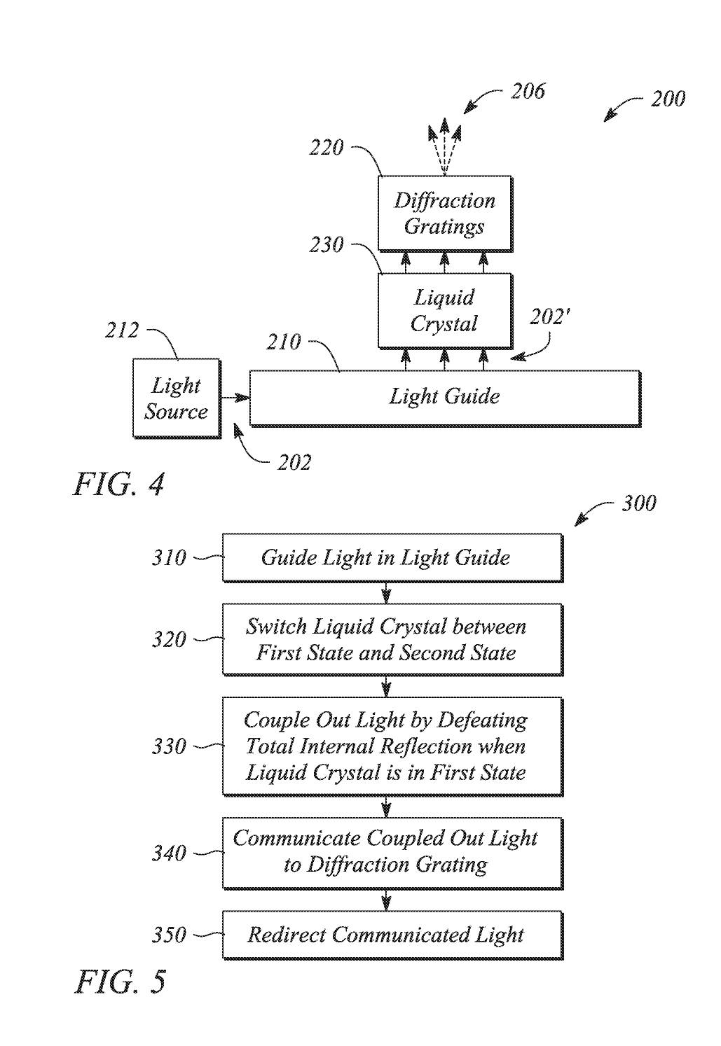

According to some examples of the principles described herein, an electronic display is provided. FIG. 4 illustrates a block diagram of an electronic display 200, according to an example consistent with the principles described herein. The electronic display 200 employs liquid crystal coupling modulation to modulate pixels of the display 200. Further, emitted modulated light 206 may be preferentially directed toward a viewing direction of the electronic display 200.

The electronic display 200 illustrated in FIG. 4 includes a light guide 210. The light guide 210 is configured to guide light 202 from a light source 212. The light guide 210 may be a backlight light guide of the electronic display 200, for example. The light 202 from the light source 212 is guided by total internal reflection between a front surface and a back surface of the light guide 210, according to some examples. The light source 212 may be substantially similar to the light source 104 described above with respect to the liquid crystal coupled light modulator 100, for example. Further, in some examples, the light guide 210 may be substantially similar to the light guide 110 described above with respect to the liquid crystal coupled light modulator 100. For example, the light guide 210 may be a slab or plate optical waveguide.

As illustrated in FIG. 4, the electronic display 200 further includes a plurality of diffraction gratings 220 adjacent to but spaced apart from a surface of the light guide 210. The plurality of diffraction gratings 220 is configured to diffractively redirect portions of the guided light 202 coupled out through the surface of the light guide 210. In particular, each diffraction grating 220 of the plurality may diffractively redirect a different coupled out portion 202′ of the guided light 202. According to some examples, the diffraction gratings 220 of the plurality are substantially similar to the diffraction grating 120 described above with respect to the liquid crystal coupled light modulator 100. For example, a diffraction grating 220 of the plurality may include or be made up of a plurality of features (e.g., grooves, ridges, bumps, holes, or combinations thereof) in a layer adjacent to but spaced apart from the surface of the light guide 210. In some examples, different ones of the diffraction gratings 220 of the plurality are selectively configured to diffractively redirect different coupled out portions 202′ of the guided light 202 and further to diffractively redirect the different coupled out portions 202′ in different directions to produce a three dimensional (3-D) electronic display 200.

The electronic display 200 further includes a liquid crystal 230 in contact with the light guide 210 and the diffraction gratings 220. The liquid crystal 230 has a selectable first refractive index state with a first refractive index to defeat total internal reflection within the light guide 210. The liquid crystal 230 has a selectable second refractive index state with a second refractive index to facilitate the total internal reflection. In particular, the first refractive index is configured to either substantially match or exceed a refractive index of the light guide 210, while the second refractive index is less than the refractive index of the light guide 210. A selection of the selectable first and second refractive index states and corresponding diffraction gratings 220 is configured to modulate the portion 202′ of coupled out light as a modulated pixel of the electronic display 200. Specifically, a pixel of the electronic display 200 includes the coupled out and diffractively redirected portion 206 of the guided light modulated by selection between the first and second refractive index states.

In some examples, the liquid crystal 230 is substantially similar to the liquid crystal 130 described above with respect to the liquid crystal coupled light modulator 100. In particular, the first refractive index state may include an orientation of molecules of the liquid crystal 230 configured to provide the first refractive index. Similarly, the second refractive index state may include another orientation of the liquid crystal molecules configured to provide the second refractive index. The first refractive index may be configured to either substantially match or exceed a refractive index of the light guide 210 for a predetermined polarization of the guided light. The second refractive index of the liquid crystal may be configured to differ from and be substantially less than the refractive index of the light guide 210 for the predetermined polarization of the guided light. The selective or controlled states of the liquid crystal molecules in a vicinity of the corresponding diffraction gratings 220 of the plurality provides modulation of light (e.g., pixels being turned ON and OFF) emitted by the electronic display 200. Electrodes (not illustrated) may be provided to selectively control diffractive coupling from individual diffraction gratings 220 of the plurality to modulate individual pixels, for example.

According to some examples of the principles described herein, a method of liquid crystal coupled light modulation is provided. In particular, the method of liquid crystal coupled light modulation employs a liquid crystal to modulate light by alternately defeating and facilitating total internal reflection within a light guide. The liquid crystal defeats total internal reflection by exhibiting a refractive index that either substantially matches or exceeds a refractive index of the light guide. The liquid crystal facilitates total internal reflection by exhibiting another refractive index that is less than the light guide material index of refraction. The method of liquid crystal coupled light modulation may employ the liquid crystal coupled light modulator 100, described above, according to some examples.

FIG. 5 illustrates a flow chart of a method 300 of liquid crystal coupled light modulation, according to an example consistent with the principles described herein. The method 300 of liquid crystal coupled light modulation includes guiding 310 light in a light guide using total internal reflection (TIR). In some examples, the light guide may be substantially similar to the light guide 110 described above with respect to the liquid crystal coupled light modulator 100. In particular, in some examples, the light guide includes a solid sheet or slab of optically transparent, substantially solid material to guide 310 the light by total internal reflection with in the sheet. Guiding 310 light in the light guide may include propagating light in the slab between a top surface and a bottom surface of the sheet.

The method 300 of liquid crystal coupled light modulation further includes switching 320 a state of a liquid crystal between a first state (i.e., a first refractive index state) and a second state (i.e., a second refractive index state). The liquid crystal is in contact with a surface of the light guide and further is sandwiched between the light guide surface and a diffraction grating. According to some examples, a refractive index of the liquid crystal in the first refractive index state substantially matches or exceeds a refractive index of the light guide to defeat total internal reflection, while the liquid crystal refractive index in the second refractive index state is less than the light guide refractive index. The liquid crystal may be substantially similar to the liquid crystal 130 described above with respect to the liquid crystal coupled light modulator 100, in some examples. Further, in some examples, the diffraction grating may be substantially similar to the diffraction grating 120 described above with respect to the liquid crystal coupled light modulator 100, descried above.

In some examples, switching 320 the state of the liquid crystal may include one or both of applying an electric field to the liquid crystal and changing the electric field applied to the liquid crystal. The electric field may be applied by using an electrode such as, but not limited to, the electrode 150 or the electrode pair 150, 150′ described above with respect to the liquid crystal coupled light modulator 100, for example.

The method 300 of liquid crystal coupled light modulation further includes coupling 330 out a portion of the guided light by defeating total internal reflection. In particular, the portion of the guided light is coupled out through the light guide surface when the liquid crystal in contact with the surface is switched 320 to the first refractive index state. However, substantially no TIR guided light is coupled out when the liquid crystal is switched 320 to the second refractive index state, according to various examples. In particular, the liquid crystal in the second state facilitates total internal reflection to substantially prevent the guided light from leaving the light guide.

In some examples, the method 300 of liquid crystal coupled light modulation further includes communicating 340 the coupled out portion of the guided light to the diffraction grating. Communicating 340 may include propagating the coupled out guide light portion through the liquid crystal, for example. In some examples, the method 300 of liquid crystal coupled light modulation further includes redirecting 350 the communicated coupled out portion of the guided light by diffractive redirection at the diffraction grating. The diffractive redirection may be according to the diffraction angle θₘ given in equation (1), for example.

Thus, there have been described examples of a liquid crystal coupled light modulator, a electronic display and a method of liquid crystal coupled light modulation that employs a liquid crystal to alternately facilitate and defeat total internal reflection of a light guide to modulate light that is coupled out of the light guide. It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A liquid crystal coupled light modulator comprising:
a light guide to guide light by total internal reflection (TIR);
a diffraction grating; and
a liquid crystal sandwiched between the diffraction grating and the light guide, the liquid crystal having a state with a first refractive index to defeat TIR at a surface of the light guide and having another state with a second refractive index to facilitate TIR,
wherein the liquid crystal in the first refractive index state is to couple out a portion of the guided light to the diffraction grating, the diffraction grating to provide diffractive redirection of the coupled out portion out of the light modulator.

2. The liquid crystal coupled light modulator of claim 1, wherein the light guide is a plate light guide comprising a sheet of optically transparent material.

3. The liquid crystal coupled light modulator of claim 1, wherein the diffraction grating is a transmissive diffraction grating.

4. The liquid crystal coupled light modulator of claim 1, wherein the first refractive index is to either substantially match or exceed a refractive index of the light guide and the second refractive index is less than the refractive index of the light guide.

5. The liquid crystal coupled light modulator of claim 1, wherein the liquid crystal is substantially confined to a portion of the surface of the light guide.

6. The liquid crystal coupled light modulator of claim 1, wherein the liquid crystal comprises a nematic liquid crystal in which the first refractive index state is characterized by a homogeneous alignment of molecules of the nematic liquid crystal and the second refractive index state is characterized by a homeotropic alignment of the nematic liquid crystal molecules, the homogeneous alignment providing the first refractive index and the homeotropic alignment providing the second refractive index.

7. The liquid crystal coupled light modulator of claim 1, further comprising a first electrode and a second electrode to apply an electric field to the liquid crystal, wherein application of the electric field is to switch the liquid crystal between the first refractive index state and the second refractive index state.

8. An electronic display comprising the liquid crystal coupled light modulator of claim 1, wherein the diffractively redirected portion of coupled out guided light under control of the liquid crystal first and second refractive index states is modulated light of a pixel of the electronic display.

9. An electronic display comprising:
a light guide to guide light from a light source by total internal reflection (TIR);
a plurality of diffraction gratings; and
a liquid crystal sandwiched between the diffraction gratings and the light guide, the liquid crystal having a state with a first refractive index to defeat TIR and another state with a second refractive index to facilitate TIR at a surface of the light guide, the liquid crystal in the first refractive index state to couple out and communicate a portion of the guided light to a diffraction grating of the plurality to be diffractively redirected,
wherein a pixel of the electronic display comprises the coupled out and diffractively redirected guided light portion modulated by selection between the first and second refractive index states.

10. The electronic display of claim 9, wherein the first refractive index state comprises an orientation of molecules of the liquid crystal to provide the first refractive index, the second refractive index state comprising another orientation of the liquid crystal molecules to provide the second refractive index, the first refractive index being substantial matched to or exceeding a refractive index of the light guide for a predetermined polarization of the guided light, the second refractive index of the liquid crystal being less than the light guide refractive index for the predetermined polarization of the guided light.

11. The electronic display of claim 9, wherein the light guide is a backlight that comprises a slab of optically transparent material having a front surface and a back surface, the liquid crystal being confined to a portion of the front surface of the light guide, the diffraction grating comprising a transmissive diffraction grating.

12. The electronic display of claim 9, wherein different ones of the diffraction gratings of the plurality are to couple out portions of the guided light in different directions to produce a three dimensional (3-D) electronic display.

13. The electronic display of claim 9, further comprising a first electrode and a second electrode, wherein application of a first voltage across the first and second electrodes is to produce the liquid crystal first refractive index state and application of a second voltage across the first and second electrodes is to produce the liquid crystal second refractive index state.

14. A method of liquid crystal coupled light modulation, the method comprising:
guiding light in a light guide using total internal reflection (TIR);
switching a liquid crystal between a first state and a second state, the liquid crystal being in contact with and sandwiched between a surface of the light guide and a diffraction grating; and
coupling out a portion of the guided light by defeating TIR when the liquid crystal is switched to the first state,
wherein a refractive index of the first state is substantially matched with or exceeds a refractive index of the light guide to defeat TIR and the refractive index in the second state is less than the light guide refractive index.

15. The method of liquid crystal coupled light modulation of claim 14, the method further comprising:
communicating the coupled out portion of the guided light to the diffraction grating; and
redirecting the communicated coupled out portion of the guided light by diffractive redirection at the diffraction grating.
